(19) United States
(12) Patent Application Publication
(10) Pub. No.: US 2016/0171170 A1
(43) Pub. Date: Jun. 16, 2016

(54) MEASURING RESPIRATION OR OTHER PERIODIC PHYSIOLOGICAL PROCESSES

(71) Applicant: ISIS INNOVATION LIMITED, Oxford, Oxfordshire (GB)

(72) Inventors: David Andrew CLIFTON, Oxford, Oxfordshire (GB); Marco PIMENTEL, Oxford, Oxfordshire (GB); Lionel TARASSENKO, Oxford, Oxfordshire (GB)

(73) Assignee: ISIS INNOVATION LIMITED, Oxford, Oxfordshire (GB)

(21) Appl. No.: 14/392,234

(22) PCT Filed: Jun. 25, 2014
(86) PCT No.: PCT/GB2014/051940

§ 371 Date: Dec. 23, 2015

(30) Foreign Application Priority Data
Jun. 27, 2013 (GB) 1311498.8

(51) Int. Cl. G06F 19/00

(52) U.S. Cl. CPC G06F 19/3437; G06F 19/3431

(57) ABSTRACT

A method of obtaining information about the rate of a periodic physiological process from a time series of measurements obtained from a patient, comprising: obtaining the time series of measurements; fitting a model defining a probability distribution over functions to the time series of measurements, wherein the model is defined by a mean function and a periodic covariance function; and outputting the result of the fitting as information about the rate of the periodic physiological process.

The present invention provides an improved way of monitoring periodic physiological processes and is particularly applicable to measuring respiratory rate.

Respiratory rate has been shown to be an important indicator of patient deterioration[4], [11], and extreme values of respiratory rate are associated with an increased risk of adverse events in hospital patients [4], [11], [5]. The importance of assessing respiratory rate has led to its inclusion in most numerical patient assessment systems, often termed early warning scores or EWS [6], the use of which is widespread. Such systems typically consist of the application of univariate scoring criteria to observational physiological variables (including the vital signs) and produce a cumulative score that can, if it exceeds a predefined threshold, lead to identification of physiological deterioration in acutely-ill hospital patients. While automated techniques exist for measuring respiratory rate, they usually require the use of equipment which might interfere with natural breathing, such as spirometry, or might be uncomfortable for the patient, such as measurement via a band that encircles the chest. The signals acquired from conventional methods, including impedance plethysmography (IP), are often unusable as a result of a poor signal-to-noise ratio and are sensitive to frequent movement artefact [12].

The ECG signal, recorded for most acutely ill patients, has been considered as a source of potentially reliable respiratory information. Respiratory activity may cause the ECG to be modulated in two fundamental ways: R-peak amplitude (RPA) modulation, which is caused by the movement of the chest due to the filling and emptying of the lungs (which in turn causes a rotation of the electrical axis of the heart and the consequent modulation of the amplitude of the ECG) [2], and respiratory sinus arrhythmia (RSA), which is a frequency modulation, corresponding to a variation in heart rate that occurs throughout the respiratory cycle [2], [8]. Much previous work exists concerning the estimation of respiratory rate from ECG or other signals, such as the photoplethysmogram or PPG, and the arterial blood pressure (ABP) waveform [18]. These approaches are based on either the RPA- or RSA-modulated signals (or a combination of both), and use a variety of algorithms based on spectral analysis [1], the continuous wavelet transform [3], neural networks [10], and autoregressive models [13], [14]. Small errors (around 1 to 2 breaths per minute) between estimates derived from these signals and reference respiratory rate values have been reported [1], [13], [14] for studies of healthy volunteers.

A drawback with these approaches, however, is that they provide a point estimate of the respiratory rate. The uncertainty associated with the estimated value cannot be directly quantified, due to the nature of the algorithms employed. Experience has shown that existing methods tend to work relatively reliably for healthy volunteers but are less successful for patients who are unwell and/or elderly. In the absence of a robust method of identifying an error associated with the point estimate of respiratory rate, a clinician is unable to distinguish between point estimates that correctly indicate the state of the patient and those that are dominated by noise.

It is an object of the invention to address at least partially one or more of the shortcomings described above in relation to the prior art.

According to an aspect of the invention, there is provided a method of obtaining information about the rate of a periodic physiological process from a time series of measurements obtained from a patient, comprising: obtaining the time series of measurements; fitting a model defining a probability distribution over functions to the time series of measurements, wherein the model is defined by a mean function and a periodic covariance function; and outputting the result of the fitting as information about the rate of the periodic physiological process.

Thus, an intrinsically probabilistic method is employed that is able to output probabilistic information about the rate of a periodic physiological process (e.g. respiratory rate). For example, the information may comprise not only an estimate of the rate of the periodic physiological process, but also a statistically derived measure of the uncertainty of the estimate (in contrast to the prior art, which is only able to output a point estimate of the rate). A clinician is therefore able to make a well informed judgement about whether a particular reading is statistically significant (which might prompt the clinician to take action if the reading is outside of a normal range for example) or statistically insignificant (i.e. dominated by noise, in which case the clinician may not react to the reading in the same way). Alternatively or additionally the information may comprise a probabilistic posterior distribution over the rate (for example as part of a joint distribution over the hyperparameters of the covariance function). This is useful if the output from the method is to be used as the input to a subsequent probabilistic inference system, where knowing the full distribution of the input is more informative than a point estimate.

Choosing a model that defines a probability distribution over functions (e.g. a Gaussian Process model) and selecting a covariance function that is periodic, enables the rate and uncertainty to be extracted directly from an analysis of the joint probability distribution over the hyperparameters of the covariance function. One of the hyperparameters will define the periodicity of the covariance function, which after fitting to the input time series of measurements will correspond to the periodicity of the underlying rate to be measured. Thus, by analysing the joint probability distribution over the hyperparameters it is possible to obtain the estimate of the rate and of the uncertainty in the rate, for example by estimating the mode and covariance of the distribution over the hyperparameters.

The use of a probabilistic framework (such as Gaussian process regression) brings all of the advantages of a principled, probabilistic approach: the uncertainty in the estimation is directly quantified; incompleteness, noise, and artefact may be handled in a robust manner; and the output may consist of a predictive posterior distribution, rather than a single estimate. Additionally, due to the generative nature of the approach, it is possible to generate data from the model, which can be useful for estimating the behaviour of respiratory rate during periods of missing data.

According to a further aspect of the invention, there is provided a patient monitor that comprises one or more sensors for receiving a time series of measurements and a processor adapted to execute a method of obtaining information from the time series of measurements according to an embodiment of the invention.

According to a further aspect of the invention, there is provided a patient monitoring system comprising a patient monitor according to an embodiment of the invention and a probabilistic inference system that uses the output from the patient monitor together with other probabilistic information about the patient obtained from the patient monitor and/or from other sources to detect an abnormal state of the patient (or to otherwise classify the state of the patient and/or make or assist with diagnosis of a condition).

The invention may be embodied in computer software adapted to execute the method on a programmed computer system. The computer software may be stored in a portable medium, in memory, or transmitted as a data signal. The programmed computer system may comprise standard computer hardware such as CPU, RAM, etc. that is well known to the skilled person.

The invention will be further described by way of example with reference to the accompanying drawings in which:

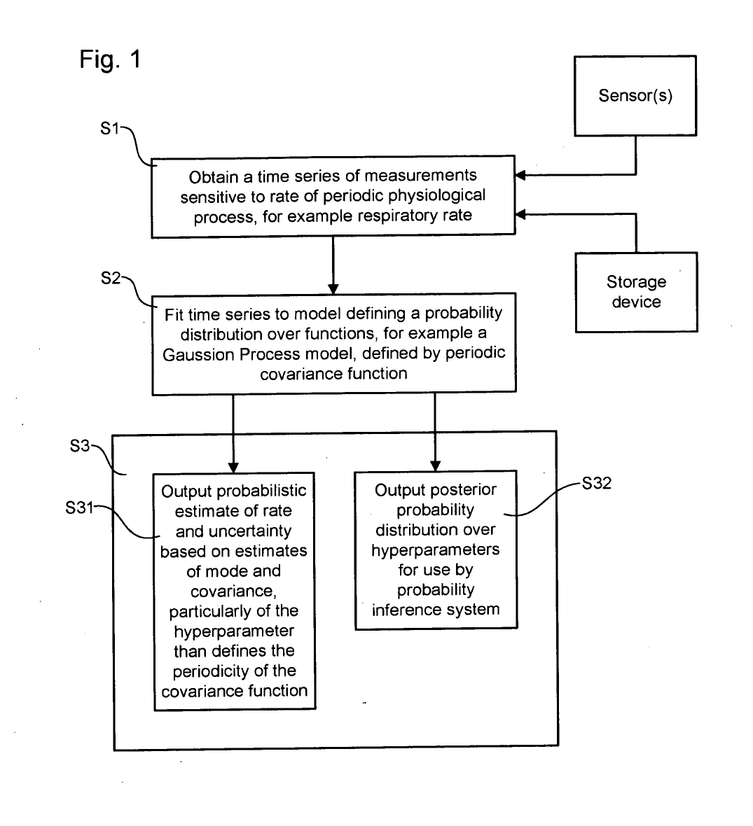

FIG. 1 is a flow chart illustrating the framework of an example method for obtaining information about the rate of a periodic physiological process;

FIG. 2 is a flow chart illustrating an example approach for obtaining the mode and covariance of hyperparameters;

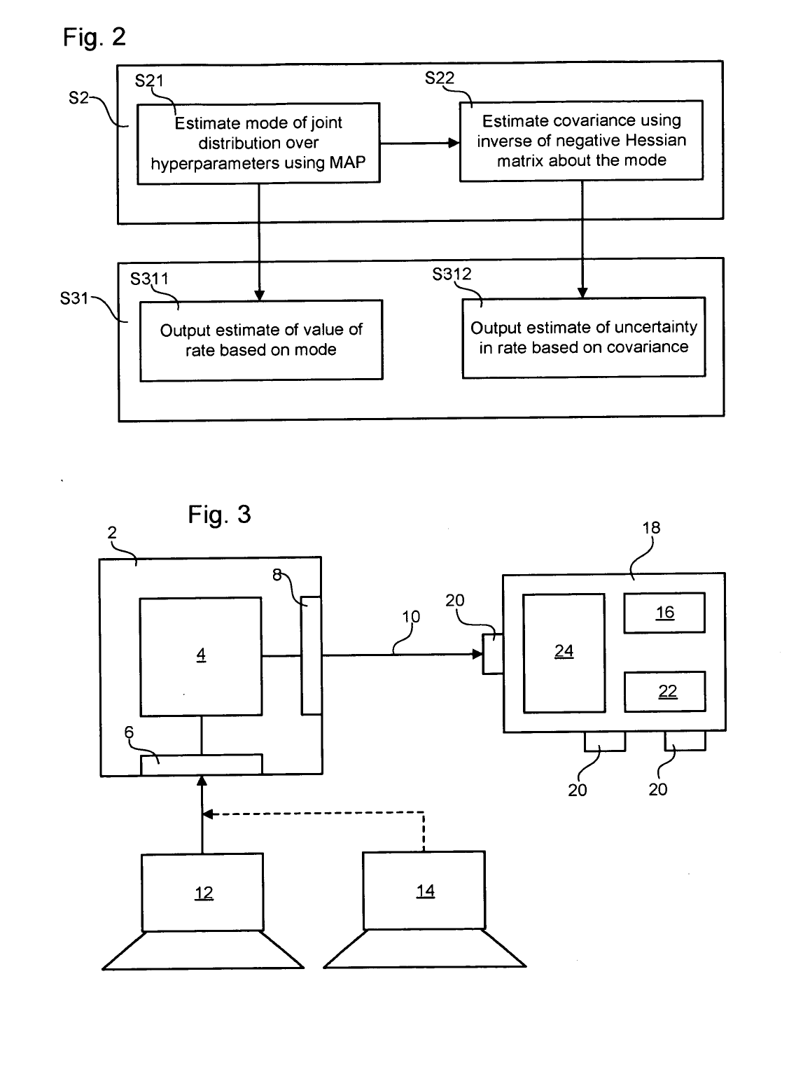

FIG. 3 depicts a patient monitor and patient monitoring system;

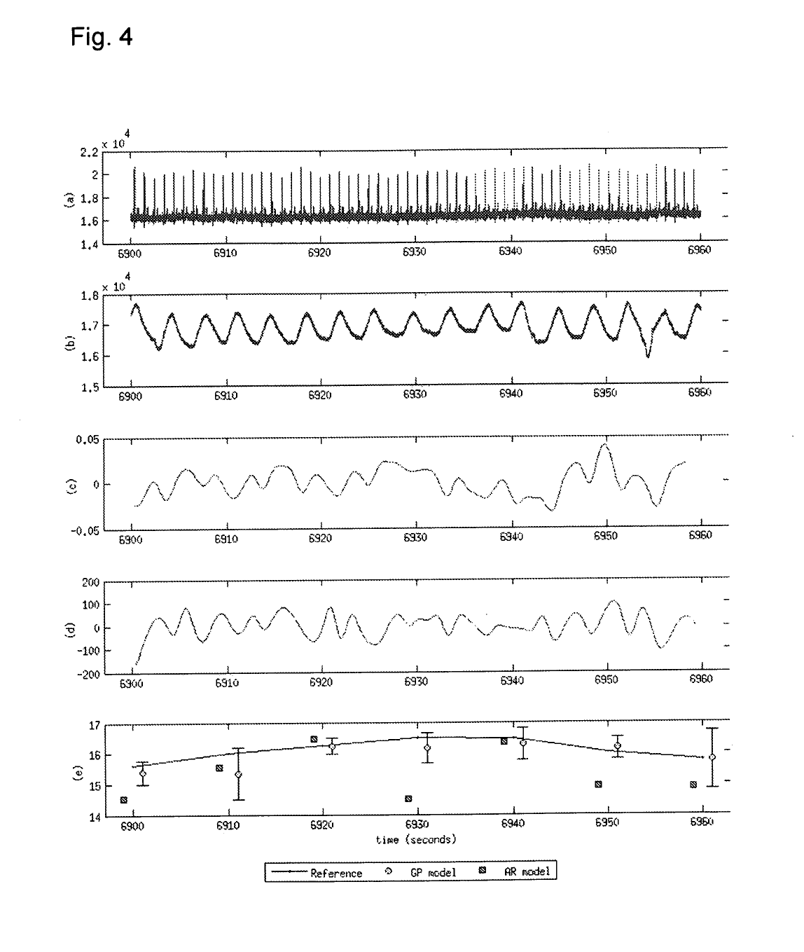

FIG. 4 depicts extraction of respiratory rate from single-lead ECG: (a) ECG signal; (b) Reference (IP) respiration signal; (c) RSA waveform from the R-R intervals time series; (d) RPA waveform from the R-peaks time series; (e) Final respiratory rate estimates from the AR- and GP-based methods;

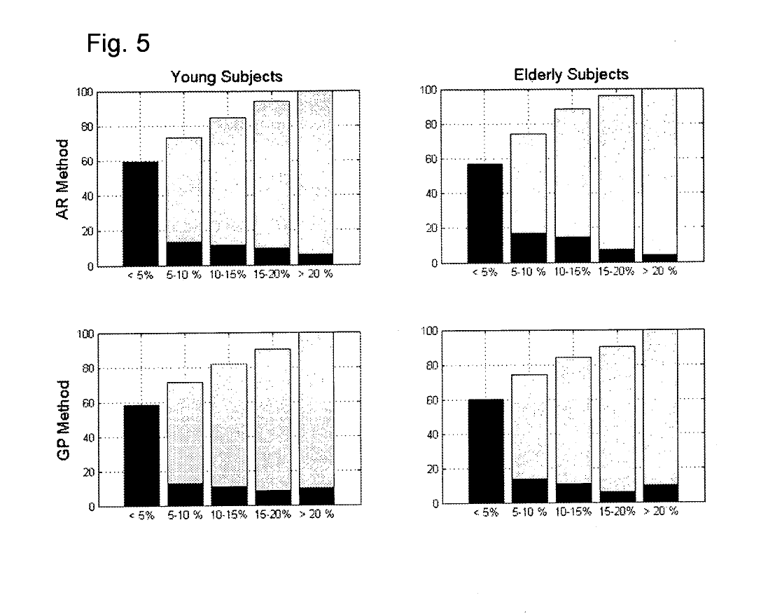

FIG. 5 depicts histograms showing the percentage error E between the proposed method and a “gold standard” reference respiratory rate as follows: data are first partitioned into 1-minute windows. The method is then used to estimate the respiratory rate on each window of data separately. The estimate of respiratory rate for each window is then compared with the reference rate, to give the percentage error E, which is shown on the x-axis. The histograms show the number of windows with different ranges of percentage error, E, using data for “young” and “elderly” subjects.

According to an embodiment, there is provided a method of obtaining information about the rate of a periodic physiological process from a time series of measurements obtained from a patient. In an embodiment, the physiological process is breathing and the rate is the respiratory rate. In another embodiment, the physiological process is pumping of blood around the body by the heart and the rate is the heart rate. The time series of measurements may consist of the output from a sensor at a plurality of different times. The output may be selected so as to be sensitive to the physiological process being measured (i.e. so that the physiological process can modulate the signal in a measurable way). Specific examples are mentioned below. The different times at which the time series of measurements are provided may be equally or irregularly spaced. The times series of measurements may comprise the output from plural different sensors at plural different times or plural outputs from the same sensor at each of a plurality of different times.

In an embodiment, the time series of data comprises either or both of R-R peaks and R-R intervals, respectively from RPA and RSA waveforms. In an embodiment, the times series of measurements comprise a time series of one or more of the following: photoplethysmogram data (acquired from pulse oximetry, or from a video camera recording an area of the patient's skin), arterial blood pressure waveform data, ECG data.

In an embodiment, as illustrated in the flow chart of FIG. 1, the method comprises the step (S1) of obtaining the time series of measurements. The time series of measurements may be obtained directly (i.e. substantially in real time) from a sensor on or in close proximity to the patient's body. Alternatively, the times series of measurements may have been obtained by a sensor at an earlier time (e.g. such that all of the time series of measurements was obtained by the sensor and stored before any of the data is used in the method of FIG. 1), in which case the time series of measurements may be retrieved from a storage device containing the earlier obtained data (e.g. over a data connection or via direct access to the storage device).

In a subsequent step (S2), a model is fitted to the time series of measurements (this step may also be referred to as a “training” step). The model is of a type that defines a probability distribution over functions. The time series of measurements represents one example of points that occur within such a function. The fitting of the model involves obtaining an estimate of the probability distribution over functions that best fits the time series of measurements. In an embodiment, the fitting involves estimating the mode and covariance of a joint distribution over hyperparameters defining the model.

The fitting process provides information about the rate of the periodic physiological process being measured, which may be output (step S3) for further processing or display for example. The output may comprise a probability distribution of the rate or an estimate of the rate and an uncertainty. The uncertainty in the rate may be derived from the quality of the fit to the time series data, or from the variance of the distribution over the rate. The model may be characterized by a covariance function that is periodic and the information about the rate may be obtained from an estimate of the distribution of the hyperparameter that defines the periodicity of the covariance function (step S31).

For example, a distribution over all of the hyperparameters defining the model may be obtained from the fitting. The mode of the distribution may be obtained, which will comprise a distinct mode value for each of the hyperparameters considered. An estimate of the rate can then be derived from the mode of the particular hyperparameter which defines the periodicity of the covariance function of the model. The uncertainty in the rate can then be obtained from the variance of that hyperparameter at the mode of the distribution of hyperparameters. The variance of this hyperparameter at the mode can be obtained from the covariance of the distribution over all of the hyperparameters.

Alternatively or additionally, the output step S3 comprises a step (S32) of outputting a posterior probability distribution over the hyperparameters for use, for example, in a probability inference system.

In an embodiment, the model is a Gaussian process model and the fitting process is an example of Gaussian process regression.

In an embodiment, the periodic covariance function (i.e. the form of the periodic covariance function) is determined using prior knowledge of the physiological process. The fact that the covariance function is periodic already encodes prior knowledge that the physiological process is periodic. The form of the periodic covariance function may however be configured to encode further prior knowledge that may be available. For example, the periodic covariance function may encode prior knowledge that the rate of the physiological process will drift through time. This may be achieved for example by including a hyperparameter representing a length scale of the periodic covariance function. An example of such a hyperparameter is the hyperparameter A, discussed below in the context of the “detailed example”. Modifying the periodic covariance function to include prior knowledge may improve (e.g. in terms of efficiency and/or accuracy) the fitting of the model to the time series of measurements.

FIG. 2 illustrates in further detail how the fitting/training step S2 and output step S31 may be configured in a particular embodiment. According to this embodiment, the fitting/training step S2 comprises a step S21, in which an estimate of the mode of a joint distribution over the hyperparameters is obtained using a maximum a posteriori (MAP) estimate. This mode is then used to output an estimate of the rate (step S311) as part of the output step S31. According to this embodiment, the fitting/training step S2 further comprises a step S22, in which the covariance is obtained using the inverse of the negative Hessian matrix about the mode obtained in step S21. The covariance can then be used to derive a quantitative measure of the uncertainty in the rate value output in step S311, which may be output in step S312.

FIG. 3 depicts an example of apparatus that could be configured to implement a method according to an embodiment. The depicted apparatus comprises a patient monitor 2 comprising a data processor 4 (comprising for example, CPU, motherboard, RAM, etc.) configured to carry out the data processing operations necessary to implement the method of obtaining information about the rate of the periodic physiological process according to an embodiment. The patient monitor 2 shown comprises an I/O interface 6 for receiving data from one or more sensors 12,14, or from a data source, in order to obtain the required time series of measurement data that is used for fitting to the model (e.g. using Gaussian process regression). The sensor(s) 12,14 may be adapted to obtain photoplethysmogram data (from either a pulse oximeter or from video camera recordings of a patient's skin), arterial blood pressure waveform data and/or ECG data for example.

The patient monitor 2 comprises a further I/O interface 8 for outputting information about the rate that has been derived from the input times series of measurement data. In the particular embodiment shown, the output data 10 is transmitted (e.g. via a network connection) to an input interface 20 of a patient monitoring system 18. The patient monitoring system 18 may be configured to store the data output from the patient monitor 2 in memory 16, for example, and/or display the data on display 22. In an embodiment, the patient monitoring system 18 comprises a probabilistic inference system 24 (which may comprise standard computer hardware programmed for carrying out a probabilistic inference method) and the patient monitor 8 may be configured to output a probabilistic posterior distribution over the rate. The probabilistic inference system 24 may be configured for example to detect an abnormal state of the patient by combining the output 10 from the patient monitor 2 with one or more further probabilistic information inputs (input via an I/O interface 20 for example) derived from other measurements performed on the patient.

### DETAILED EXAMPLE

The presence of respiratory information within the electrocardiogram (ECG) signal is a well-documented phenomenon. In the detailed example described below, a Gaussian process framework is used for the estimation of respiratory rate from different sources of modulation in a single-lead ECG. A periodic covariance function is used to model the frequency- and amplitude-modulated time series measurements derived from the ECG, where the hyperparameters of the process are used to derive the respiratory rate. In the particular example described, the approach is evaluated using data taken from 40 healthy subjects each with 2 hours of monitoring, containing ECG and respiration (impedance plethysmography, or IP) waveforms. Results indicate that the accuracy of the example method is comparable with that of existing methods, which are non-probabilistic, but with the advantages of the example method being a principled probabilistic approach, including the direct quantification of the uncertainty in the estimation.

To illustrate the efficacy of an embodiment of the invention, the method was applied to data from the Physiobank/Physionet Fantasia database[7], [9]. The latter consists of data acquired from two subgroups of volunteers: 20 “young” (21-34 years old) and 20 “elderly” (60-85 years old) healthy subjects who underwent 120 minutes of continuous supine rest (while watching the film “Fantasia”). Continuous single-lead ECG and respiration (IP) signals were collected. Each subgroup of subjects includes equal numbers of men and women.

Respiratory rate was computed using methods to be described later, with windows of data of 1 minute duration, with successive windows having 50 s overlap (i.e., a new estimate is produced every 10 s).

### A. Extracting the Respiratory Waveforms

ECG beat detection was performed using the Hamilton and Tompkins algorithm [15]. The amplitude of the resulting series of R-peaks was determined in order to derive the RPA waveform. The intervals between successive R-peaks were also calculated to derive the R-R time series, which corresponds to the RSA waveform.

B. Calculation of Respiratory Rate from the RPA and RSA Waveforms

According to an embodiment, respiratory rate is extracted from the RPA and RSA waveforms using Gaussian process (GP) regression. This offers a framework for performing inference using time-series data, in which a probability distribution over a functional space is constructed. We consider the RPA and RSA waveforms to be two separate functions, from which we can perform inference using the GP framework. In comparison with many prior art approaches based on algorithms such as spectral analysis, continuous wavelet transforms or autoregressive models, the GP framework can be applied efficiently to the analysis of data that may be sampled at irregular intervals, as with the R-peaks and R-R intervals contained in the RPA and RSA waveforms, respectively.

The GP is a stochastic process [16] that expresses a dependent variable y in terms of an independent variable x, via a latent function ƒ(x). This function can be interpreted as being a probability distribution over functions,

y=ƒ(x)˜GP(m(x),k(x,x′))

where m(x) is the mean function of the distribution and k is a covariance function which describes the coupling between two values of the independent variable as a function of the (kernel) distance between them. The covariance function encodes our assumptions concerning the structure of the time series that we wish to model [16]. Valid covariance functions can take a variety of forms, with the constraint that they are positive semi-definite.

In the present example, x, y will be the times of the observations and the values of the observations, respectively, comprising univariate pairs (x,y). A periodic covariance function is defined as follows, denoted r=∥xₚ−x_{q}∥ as the (Euclidean) distance between two independent variables, xₚ and x_{q}:

$$k ( r ) = {σ}_{0}^{2} exp [ - \frac{{sin}^{2} ( ( 2 π / {P}_{L} ) r}{2 {λ}^{2}} ] ,$$

in which the hyperparameters σ₀ and λ give the amplitude and length-scale of the latent function, respectively. P_{L} is the length of the period of the covariance function and provides a direct estimate of the respiratory rate. The selection of a covariance function k that is periodic represents the prior knowledge of typical waveforms from which respiration may be derived, which are expected to be periodic. It is assumed that the observations are corrupted by additive Gaussian noise with variance component ε². Thus, the full covariance function is given by

V(xₚ,x_{q})=k(xₚ,x_{q})+ε²δ(∥xₚ−x_{q}∥)

where δ is the Kronecker delta, for which δ=1 if p=q, and S=0 otherwise. Here, s is the noise variance. The values of the hyperparameters are learned from univariate respiration waveforms which consist of n observations, D={(xᵢ,yᵢ)}|i=1, . . . , n). The xᵢ and yᵢ points represent the independent and dependent variable values respectively.

The nature of the GP is such that, conditional on observed data, predictions can be made about the function values ƒ(x_{*}) at any (“test”) location of the index set x_{*}. The distribution of the values off at point x_{*} is Gaussian, with mean and covariance given by

ƒ_{*}|x_{*},x,y˜N(ƒ_{*},Var[ƒ_{*}])

in which x, y are the “training data”, D, and where N denotes the Normal or Gaussian distribution with mean and variance parameters. The above makes it possible to determine the following predictive equations for GP regression, for which it is assumed that the mean function m is zero,

ƒ̅_{*}=m(x_{*})+k(x_{*},x_{*})^{T}V(x,x)⁻¹(y−m(x))

Var[ƒ_{*}]=k(x_{*},x_{*})−k(x,x_{*})^{T}V(x,x)⁻¹k(x,x_{*})

In the above, boldface terms k, V refer to the matrix equivalents of k, V defined earlier. In the present example, for the particular dataset considered, empirical selection of suitable prior values of the hyperparameters were σ₀=1, λ=1 and ε=0.01. For the period P_{L}, a uniform prior distribution was selected over the range P_{L}=(1.5 . . . 10), which corresponds to plausible respiratory rate values of 6 to 40 breaths per minute.

A full Bayesian treatment of GP regression requires integration over the posterior distribution of the hyperparameters. Even though most calculations in the GP regression framework are analytically tractable, the integral over the posterior of the hyperparameters often is not. The integration over the posterior of the hyperparameters p(θ|D), with hyperparameters θ={σ₀,λ,P_{L},ε}, can be approximated by a point via the maximum a posteriori (MAP) estimate

$$\begin{matrix}\hat{θ} = arg {max}_{θ} p ( θ \vert D ) \\ = arg {min}_{θ} [ - log p ( D \vert θ ) - log p ( θ ) ]\end{matrix}$$

In this approximation, the distribution over the hyperparameters is assigned a point mass at the mode of the posterior, allowing the marginal distribution of the latent function to be approximated by p(ƒ|D)≠p(ƒ|D,\hat{θ}). This approach is computationally attractive. The grid search approximation to the full integral over the posterior distributions of the hyperparameters follows the work of Rue et al. [17], in which the posterior mode \hat{θ} is first located by maximising the log-posterior distribution log p(θ/y), and the shape of the log-posterior is approximated with a Gaussian, the covariance of which is the inverse of the negative Hessian at the mode (more details may be found in [16], [17]).

In the present example, for each 60 s window, the RPA and RSA time series are first normalized using a zero mean, unit-variance transformation. A Gaussian process is then fitted to each of the waveforms, using the procedure described above to obtain an estimate of both the value and uncertainty of the respiratory rate value (directly from the distribution over the period, P_{L}). The estimate with lower uncertainty (i.e., where the posterior distribution had lowest variance) was chosen as the final estimate of the respiratory rate for that window.

The performance of the present example was compared with that of the autoregressive model, a parametric, non-probabilistic spectral analysis technique that has been successively applied to this problem [13], [14]. This method requires equispaced samples, and so the time series of R-R intervals and R-peaks were resampled at 4 Hz, and the RPA and RSA waveforms were obtained using linear interpolation. Each of the waveforms was then filtered using an FIR band-pass filter with cut-off frequencies of 0.1 and 0.6 Hz (equivalent to respiratory rates of 6-36 breaths per min). Following previous methods, the steps involved in estimating respiratory rates are as follows for each of the RPA and RSA waveforms: (i) fit an AR model to each 60 s window of resampled data; (ii) reject all poles with frequencies corresponding to respiratory rates outside the range of physiologically-plausible values (6-36 breaths per min); (iii) keep all poles with magnitude of at least 95% of the remaining highest-magnitude pole; and (iv) select the pole remaining that has the smallest angle. The frequency associated with this pole is the estimate of respiratory rate for this waveform. Finally, the respiratory rate corresponding to the pole with the highest magnitude (extracted from the two waveforms) was selected as the final respiratory rate for that window.

### C. Reference Respiratory Rate

A reference respiratory rate was calculated from the IP signal in the database using both an extrema detection algorithm and an AR-based method. With the latter, the respiration signal was down-sampled to 4 Hz, after applying an anti-aliasing filter, and a 0.1-0.6 Hz FIR band-pass filter was then applied. The resulting waveform was then fitted to an AR model and the respiratory pole identified using the same method as described in the previous section. Only those reference waveforms for which the agreement between both extrema- and AR-based estimates was within 3 breaths per min were retained (“valid windows”). As a result, 72% of the available windows were deemed to be “valid”. This approach ensures only the highest quality reference values are considered by potentially eliminating regions of low IP quality.

### Results

Over the entire database, the mean reference respiratory rate was 18.3±2.9 breaths per min (17.9±2.8 for the young subjects and 18.8±3.0 for the elderly subjects). FIG. 4 shows an example from a 1-minute window of data. In general, as illustrated in the figure, it can be seen that the values extracted using the AR method and the proposed GP method are close to the corresponding reference respiratory rate. However, using the GP-based approach, it is possible explicitly to quantify the uncertainty in the estimated value by computing the variance of the posterior distribution drawn from the related period length parameter (h) of the GP. The uncertainty of an estimate may be due to the presence of noise in the derived respiration waveform (which in turn may be caused by a bad performance of the beat detector), which precludes an accurate estimation of the respiratory rate. In such cases, the precision (inverse of the variance) of the estimate is very low.

The performances of the AR and proposed methods were assessed by calculating the mean absolute error (MAE) in breaths per min,

$$MAE = \frac{1}{n} {\sum }_{i = 1}^{n} \vert {\hat{y}}_{i} - {y}_{ref , i} \vert ,$$

where n is the number of valid windows over the entire database of both groups (young and elderly subjects), ŷᵢ is the estimated respiratory rate (mean posterior value in the case of the GP-based method) y_{ref,i} is the reference respiratory rate for window i. Table I shows MAE for different ranges of respiratory rates.

TABLE I
MEAN ABSOLUTE ERROR IN BREATHS PER MIN (BPM)

| | | |
|---|---|---|
| | Young | Elderly |
| Range of | subjects | subjects |

| reference RR | | AR | GP | AR | GP |
|---|---|---|---|---|---|
| All data | | 1.26 | 1.31 | 1.62 | 1.59 |
| ≦12 | bpm | 1.66 | 1.68 | 1.52 | 1.57 |
| 12-16 | bpm | 1.09 | 1.21 | 1.35 | 1.29 |
| 16-20 | bpm | 1.21 | 1.19 | 1.12 | 1.22 |
| >20 | bpm | 1.90 | 1.71 | 2.09 | 1.82 |

While both methods show similar performance, both performed better for the young group of patients. As the respiratory rate increases (or decreases), the estimation errors also increase. Crucially, it can be seen that the method disclosed herein is more accurate for higher respiration rates in the elderly, which is the typical target population. To assess further the performance of the method, the percentage of valid windows for different ranges of the percentage error were calculated (see FIG. 5), which is given by

$$E = \frac{MAE}{\vert {μ}_{ref} \vert} \times 100 ,$$

where μ_{ref} is the mean of the reference respiratory rates over each of the two patient groups. This is a useful metric since the significance of MAE is different depending on the actual respiratory rate. It can be seen that both methods perform similarly.

Thus, a novel probabilistic approach for extracting respiratory rate from time-series sensor data using Gaussian processes is provided. The method is able to give not only a point estimate of the breathing rate, but, for the first time, a measure of uncertainty of the estimate. By applying this technique to a database of 40 healthy subjects, it has been demonsbated that it is possible to match the performance of the existing state-of-the-art, while bringing the benefits of a probabilistic framework.

### REFERENCES

[1] K. H. Chon, S. Dash, and K. Ju. Estimation of respiratory rate from photoplethysmogram data using timefrequency spectral estimation. IEEE Transactions on Biomedical Engineering, 56(8):2054-2063, 2009.
[2] G. D. Clifford, F. Azuaje, P. McShany, et al. Advanced methods and tools for ECG data analysis. Artech House, 2006.
[3] D. Clifton, J. G. Douglas, P. S. Addison, and J. N. Watson. Measurement of respiratory rate from the photoplethysmogram in chest clinic patients. Journal of clinical monitoring and computing, 21(1):55-61, 2007.
[4] M. Cretikos, J. Chen, K. Hillman, R. Bellomo, S. Finfer, A. Flabouris, et al. The objective medical emergency team activation criteria: A case-control study. Resuscitation, 73(1):62-72, 2007.
[5] J. F. Fieselmann, M. S. Hendryx, C. M. Helms, and D. S. Wakefield. Respiratory rate predicts cardiopulmonary arrest for internal medicine inpatients. Journal of general internal medicine, 8(7):354-360, 1993.
[6] H. Gao, A. McDonnell, D. A. Harrison, T. Moore, S. Adam, K. Daly, L. Esmonde, D. R. Goldhill, G. J. Parry, A. Rashidian, et al. Systematic review and evaluation of physiological track and trigger warning systems for identifying at-risk patients on the ward. Intensive care medicine, 33(4):667-679, 2007.
[7] Goldberger, A. L. et al. Physiobank, physiotoolkit, and physionet. Circulation, 101(23):e215-e220, 2000 (June 13).
[8] J A Hirsch and B. Bishop. Respiratory sinus arrhythmia in humans: how breathing pattern modulates heart rate. American Journal of Physiology-Heart and Circulatory Physiology, 241(4):H620H629, 1981.
[9] N. Iyengar, C K Peng, R. Morin, A L Goldberger, and L. A. Lipsitz. Age-related alterations in the fractal scaling of cardiac interbeat interval dynamics. American Journal of Physiology-Regulatory, Integrative and Comparative Physiology, 271(4):R1078R1084, 1996.
[10] A. Johansson. Neural network for photoplethysmographic respiratory rate monitoring. Medical and Biological Engineering and Computing, 41(3):242-248, 2003.
[11] J. Kause, G. Smith, D. Prytherch, M. Parr, A. Flabouris, K. Hillman, et al. A Comparison of Antecedents to Cardiac Arrests, Deaths and Emergency Intensive Care Admissions in Australia and New Zealand, and the United Kingdom the ACADEMIA study. Resuscitation, 62(3):275-282, 2004.
[12] V. H. Larsen, P. H. Christensen, H. Oxhoj, and T. Brask. Impedance pneumography for long-term monitoring of respiration during sleep in adult males. Clinical Physiology, 4(4):333-342, 1984.
[13] J. Lee and K H Chon. Respiratory rate extraction via an autoregressive model using the optimal parameter search criterion. Annals of biomedical engineering, 38(10):3218-3225, 2010.
[14] C. Orphanidou, S. Fleming, S A Shah, and L. Tarassenko. Data fusion for estimating respiratory rate from a single-lead ecg. Biomedical Signal Processing and Control, 2012.
[15] J. Pan and W. J. Tompkins. A real-time QRS detection algorithm. Biomedical Engineering, IEEE Transactions on, (3):230-236, 1985.
[16] C. E. Rasmussen and C. K. I. Williams. Gaussian processes for machine learning, volume 1. MIT press Cambridge, Mass., 2006.
[17] H. Rue, S. Martino, and N. Chopin. Approximate Bayesian inference for latent Gaussian models by using integrated nested Laplace approximations. Journal of the royal statistical society: Series b (statistical methodology), 71(2):319-392, 2009.
[18] N. Shamim, M. Atul, C. Gari D, et al. Data fusion for improved respiration rate estimation. EURASIP Journal on advances in signal processing, 2010, 2010.

1. A method of obtaining information about the rate of a periodic physiological process from a time series of measurements obtained from a patient, comprising:
obtaining the time series of measurements;
fitting a model defining a probability distribution over functions to the time series of measurements, wherein the model is defined by a mean function and a periodic covariance function; and
outputting the result of the fitting as information about the rate of the periodic physiological process.

2. The method according to claim 1, wherein the form of the periodic covariance function is determined using prior knowledge of the physiological process.

3. The method according to claim 2, wherein the periodic covariance function encodes prior knowledge that the rate of the physiological process will drift through time by including a hyperparameter representing a length scale of the periodic covariance function.

4. The method according to claim 1, wherein the output information comprises an estimate of the rate and of an uncertainty in the estimation of the rate.

5. The method according to claim 1, wherein the output information comprises a probabilistic posterior distribution over the rate.

6. The method according to claim 1, comprising:
estimating the mode and covariance of a distribution of one or more hyperparameters defining the covariance function based on the fitting, wherein:
the output information comprises an estimate of the rate based the estimated mode; and
the output information comprises an uncertainty in the estimate of the rate based on the estimated covariance.

7. The method according to claim 6, wherein the estimate of the rate is obtained from the estimated mode of a hyperparameter defining the periodicity of the covariance function of the model and the uncertainty in the rate is obtained from the variance of the distribution of the hyperparameter defining the periodicity of the covariance function of the model at the mode.

8. The method according to claim 1, wherein the model is a Gaussian Process.

9. The method according to claim 1, wherein the physiological process is a respiratory rate.

10. The method according to claim 9, wherein the time series of data comprises R-R peaks and R-R intervals obtained respectively from RPA and RSA waveforms.

11. The method according to claim 9, wherein the time series of measurements comprises a time series of one or more of the following: photoplethysmogram data, acquired for example from a pulse oximeter or a video camera recording of a patient's skin, arterial blood pressure waveform, ECG.

12. The method according to claim 1, wherein the hyperparameters comprise a hyperparameter that defines the period of the covariance function and is equal or directly proportional to the period of the physiological process.

13. The method according to claim 1, wherein the covariance function is defined as follows:
V(xₚ,x_{q})=k(xₚ,x_{q})+ε²δ(∥xₚ−x_{q}∥)
with k being given as follows:
$$k ( r ) = {σ}_{0}^{2} exp [ - \frac{{sin}^{2} ( ( 2 π / {P}_{L} ) r}{2 {λ}^{2}} ]$$
and in which the hyperparameters are σ₀, λ, P_{L}, and ε, where σ₀ and λ give the amplitude and length-scale of the latent function, respectively, P_{L} defines the period of the covariance function, ε² represents the variance of an additive noise component, wherein δ is the Kronecker delta, for which δ=1 if p=q, and δ=0 otherwise, and xₚ and x_{q} represent two independent variables.

14. A patient monitor comprising:
a sensor for receiving a time series of measurements that are affected by a periodic physiological process;
a data processor adapted to execute the method of claim 1 to obtain information about the rate of the periodic physiological process from the time series of measurements.

15. The patient monitoring system comprising:
a patient monitor according to claim 14 configured to output a probabilistic posterior distribution over the rate as the information about the rate; and
a probabilistic inference system configured to detect an abnormal state of the patient by combining the output from the patient monitor with one or more further probabilistic information inputs derived from measurements performed on the patient.

16. The computer program comprising program code means for executing on a programmed computer system the method of claim 1.

17. (canceled)

18. (canceled)
